(19) United States
(12) Patent Application Publication
(10) Pub. No.: US 2023/0117377 A1
(43) Pub. Date: Apr. 20, 2023

(54) COMPOSITE ADDITIVE STRUCTURE AND COMPOSITE ADDITIVE MANUFACTURING EQUIPMENT

(71) Applicant: National Taiwan University of Science and Technology, Taipei (TW)

(72) Inventors: Jeng-Ywan Jeng, Taipei (TW); Mayur Jiyalal Prajapati, Taipei (TW); Ajeet Kumar, Taipei (TW)

(21) Appl. No.: 17/505,608

(22) Filed: Oct. 19, 2021

(51) Int. Cl. B29C 64/245; B29C 64/209; B29C 64/336; B29C 64/295; B33Y 30/00; B33Y 70/10

(52) U.S. Cl. CPC B29C 64/245; B29C 64/209; B29C 64/336; B29C 64/295; B33Y 30/00; B33Y 70/10

(57) ABSTRACT

A composite additive structure comprising a three-dimensional base structure and a filled structure is provided. The three-dimensional base structure comprises a shell and a cavity enclosed by the shell. The filled structure is filled in the cavity and connected to the shell to form a solid composite structure. A composite additive manufacturing equipment includes a forming stage, a first material supply module and a second material supply module. The forming stage includes a forming member. The first material supply module provides a first material stacked on the forming member layer by layer to form the three-dimensional base structure. The second material supply module provides a second material filled in the cavity of the three-dimensional base structure to obtain the composite additive structure. The second material can be filled in the three-dimensional base structure using three filling strategies: local filling, layer filling and global filling.

### BACKGROUND OF THE INVENTION

### Field of the Invention

The invention relates to a technical field of additive manufacturing technology, and more particularly to a composite additive structure constituted by a three-dimensional base structure and a filled structure filled therein which is manufactured in a single process, and also related to a composite additive manufacturing equipment for manufacturing the composite additive structure.

### Description of the Related Art

The additive manufacturing technology is to divide a three-dimensional product model into multiple two-dimensional layers. Afterward, each layer is formed by a material based on the designed structure, and each layer is stacked to the previously formed layers. Finally, a product having a three-dimensional structure is obtained. In this way, the additive manufacturing technology can be utilized to produce products having complex structures, which requires a relatively high manufacturing cost when the traditional processing technologies are used to manufacture the same.

However, the conventional three-dimensional products formed by additive manufacturing technology are made by a single material; for example, the three-dimensional structure formed through stacking multiple lattice-like units disclosed in U.S. patent application Ser. No. 17/083,279 and U.S. Pat. No. 10,881,167 is used as the shock-absorbing structure of the shoe sole. However, such a three-dimensional structure product made by a single material may limit the adjustment of mechanical properties and cannot be widely used. Multiple processes will complicate the overall technology procedure, and the multiple processes mean higher manufacturing costs. Therefore, a procedure including multiple processes to fabricate a composite structure combined with different materials has been developed to reduce manufacturing time and costs.

### BRIEF SUMMARY OF THE INVENTION

The object of the present invention is to provide a composite additive structure with a composite additive manufacturing equipment for manufacturing the composite laminate structure, which produces a composite additive structure with a material filled in a three-dimensional base structure formed by another material. The mechanical properties of the product can be adjusted in a wide range through the composite layered structure in order to increase the scope of application. In addition, the present invention integrates the processes of additive manufacturing and material filling into one single manufacturing process and can apply Direct Digital Manufacture, thereby saving process and operation time and further saving overall manufacturing costs.

An embodiment of a composite additive structure of the invention includes a three-dimensional base structure and a filled structure. The three-dimensional base structure is formed by additive manufacturing process with a supportless structure, wherein the three-dimensional base structure comprises a shell and a cavity enclosed by the shell. The three-dimensional base structure could be formed using polymer, ceramic, or metal. The unfilled structure is filled in the cavity and connected to the shell to form a solid composite structure.

In another embodiment, the three-dimensional base structure comprises of a plurality of lattice unit cells which are hollow. The lattice unit cells are stacked in a first direction, a second direction, and a third direction, each of the lattice unit cells comprises a unit shell and a unit cavity enclosed by the unit shell. The unit shell of each of the lattice unit cell is connected to the unit shell of the adjacent lattice unit cell in the first direction, the second direction, and the third direction, and the filled structure is formed in the unit cavities.

In another embodiment, each of the lattice unit cell has through holes on the unit shell in the first direction, the second direction, or the third direction; the unit cavity of each of the lattice unit cell communicates with the unit cavity of the adjacent lattice unit cell through the through holes, and the filled structure filled in each of the unit cavity is connected to the filled structure filled in the adjacent unit cavity.

In another embodiment, the unit shell of each of the lattice unit cell comprises a spherical shell and a plurality of flat circular walls; the flat circular walls are disposed on the spherical shell in the first direction, the second direction, and the third direction, and the through holes are formed on the flat circular walls in at least one of the first direction, the second direction, and the third direction.

In another embodiment, the flat circular wall has a thickness less, equal to, or greater than that of the spherical shell. The thickness of a flat circular wall can vary in the first direction, the second direction, and the third direction.

In another embodiment, the flat circular walls of the lattice unit disposed at the outermost side of the three-dimensional base structure and having no connection with the adjacent lattice unit are closed.

In another embodiment, a ratio of the thickness of the unit shell over the length of each of the lattice units ranges from 0.05 to 0.3, and a ratio of the volume of the unit cavity over the total volume of the lattice unit ranges from 0.1 to 0.7.

In another embodiment, the filled structure is formed by liquid material, gel material, foam material, or powder material. The second material can be fully or partially filled in a three-dimensional additive structure.

An embodiment of composite additive manufacturing equipment includes a forming stage, a first material supply module, and a second material supply module. The forming stage includes a forming member. The first material supply module provides a first material stacked on the forming member layer by layer to form the three-dimensional base structure of the composite additive structure. The second material supply module provides a second material filled in the cavity of the three-dimensional base structure to obtain the composite additive structure.

In another embodiment, the second material can be filled into the cavity using three filling strategies. First strategy includes second material filling in individual unit lattice cell, also called as local filling. Second strategy includes material filling in horizontal and/or vertical array of lattice unit cells, also called as layer filling. Third strategy includes material filling in a complete three-dimensional additive structure through an opening, also called as global filling.

In another embodiment, the second material is a liquid material; the second material supply module further comprises a pressurizing member pressurizing the second material to be squeezed from the second nozzle into the cavity of the three-dimensional base structure.

In another embodiment, the second material comprises a first composite material and a second composite material; the first composite material and the second composite material are mixed in the second nozzle to generate a foam material which is squeezed from the second nozzle into the cavity of the three-dimensional base structure.

In another embodiment, the second material is powder material, the second nozzle comprises a main body, and a screw disposed in the main body, the second material is transmitted to the main body and pushed by the screw, whereby the second material is squeezed from the second nozzle into the cavity of the three-dimensional base structure.

The second material is filled into the three-dimensional base structure manufactured by the additive manufacturing technology with the first material and forms the filled structure therein, whereby the composite additive structure of the present invention having filled structure of the second material enclosed by the shell made of the first material enclosing is obtained. The three-dimensional base structure can be any shape. The volume proportion of the cavity to the entire three-dimensional base structure can be adjusted to obtain different combinations of the filled structure and the three-dimensional base structure, whereby the composite additive structures having different mechanical properties are thus obtained. In addition, the composite additive manufacturing equipment of the present invention includes the first material supply module and the second material supply module. The first material supply module provides the first material to form the three-dimensional base structure on the forming member, and the second material supply module provides the second material filled in the chamber. The second material supply module have different structures according to the second material for the discharge of the second material.

The second supply module is a universal material supply module wherein it can supply different materials in different lattice unit cells in the same lattice structure, for example, liquid in one lattice unit cell, foam in the next lattice unit cell, and so on and so forth

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a composite additive structure of the invention;

FIG. 2 is a perspective view of an embodiment of a lattice unit cell of a composite additive structure of the invention;

FIGS. 3 to 6 are schematic views of a single process for forming the three-dimensional base structure and the filled structure of the invention;

FIG. 7 is a schematic view of another embodiment of a composite additive structure of the invention;

FIGS. 8, 9, 10 and 11 depict three different types of filling strategies of the second material into the three dimensional base structure of the invention;

FIG. 12 is a schematic view of an embodiment of an additive manufacturing equipment of the invention;

FIG. 13 is a schematic view of a first embodiment of a second material supply module of the additive manufacturing equipment of the invention;

FIG. 14 is a schematic view of a second embodiment of a second material supply module of the additive manufacturing equipment of the invention; and

FIG. 15 is a schematic view of a third embodiment of a second material supply module of the additive manufacturing equipment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

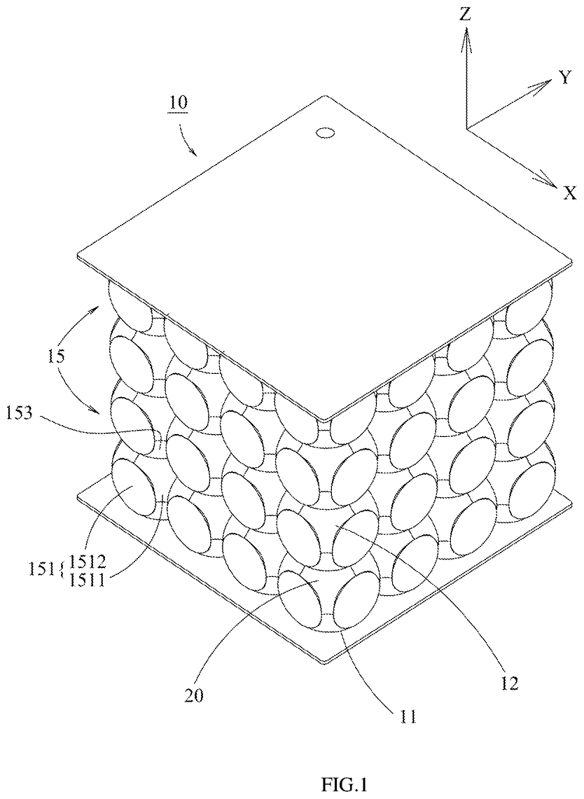

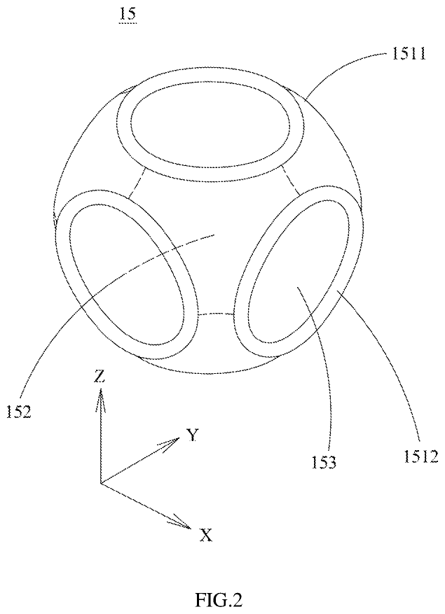

Referring to FIGS. 1 and 2, an embodiment of a composite additive structure of the invention, is shown. The composite additive structure of the present embodiment includes a three-dimensional base structure 10 manufactured by the additive manufacturing technology and a filled structure 20 made by material filled in the three-dimensional base structure 10. The three-dimensional base structure 10 of the embodiment is manufactured by the material extrusion (MEX) process. The three-dimensional base structure 10 includes a shell 11 stacked layer by layer with a first material. The shell 11 has a closed shape and form a cavity 12 there within. A second material is filled in the cavity 12 to form the filled structure 20.

As shown in FIGS. 1 and 2, the three-dimensional base structure 10 includes a plurality of lattice unit cells 15, which are hollow. The lattice unit cells 15 are stacked along a first direction X, a second direction Y, and a third direction Z to constitute a three-dimensional array. Each of the lattice unit cells 15 includes a unit shell 151 and a unit cavity 152 enclosed by the unit shell 151. The unit shell 151 of one lattice unit cell 15 is connected to the unit shell 151 of adjacent lattice unit cells 15 in the first direction X, the second direction Y, and the third direction Z. The filled structure 20 is formed in the unit cavities 152.

The unit shell 151 of the lattice unit cell 15 of the present embodiment includes a spherical shell 1511 and a plurality of flat circular walls 1512. The flat circular walls 1512 are disposed at positions on the spherical shell 1511 in the first direction X, the second direction Y, and the third direction Z. That is, the flat circular walls 1512 are disposed on the spherical shell 1511 at opposite sides along the first direction X. Similarly, the flat circular walls 1512 are disposed on the spherical shell 1511 at opposite sides along the second direction Y and the third direction Z. Therefore, each lattice unit cell 15 is connected to adjacent lattice unit cell 15 at the flat circular walls 1512 which provide a large area for connection, whereby the lattice unit cells 15 are connected to each other more compactly to obtain a higher structural strength. The thickness of the flat circular wall 1512 is smaller than, equal to or greater than the thickness of the spherical shell 1511. The thicknesses of the spherical shell 1511 and the flat circular wall 1512 can be designed before the manufacture of the three-dimensional base structure 10.

Each lattice unit 15 has through holes 153 formed on the unit shell 151 in the first direction X, the second direction Y or the third direction Z. The unit cavity 152 of each lattice unit cell 15 communicates with the unit cavity 152 of adjacent lattice unit cells 15, and the filled structure 20 filled in each unit cavity 152 of each lattice unit 15 is connected to the filled structure 20 filled in the unit cavities 152 of adjacent lattice unit cells 15. That is, the through holes 153 are formed on the flat circular walls 1512 located in the first direction X, the second direction Y, or the third direction Z. Therefore, when the spherical shell 1511 of each lattice unit cell 15 is connected to the spherical shells 1511 of adjacent lattice unit cells 15, the unit cavity 152 communicates with each other through the through holes 153 formed on the flat circular wall 1512. The through holes 153 can be formed on the flat circular wall 1512 in one of the first direction X, the second direction Y, and the third direction Z. The through holes 153 can be formed on the flat circular wall 1512 in both the first direction X and the second direction Y, in both the first direction X and the third direction Z or in both the second direction Y and the third direction Z. A ratio of the diameter of the through hole 153 over the flat circular wall 1512 ranges from 0 to 1. The through holes 153 in the first direction X, the second direction Y, and the third direction Z have an equal diameter. In another embodiment, the through holes 153 in the first direction X, the second direction Y, and the third direction Z have different diameters. A ratio of a thickness of the unit shell 151 over the length of each of the lattice unit cells 15 ranges from 0.05 to 0.3, and a ratio of the volume of the unit cavity 152 over the total volume of the lattice unit 15 ranges from 0.1 to 0.7.

The flat circular walls 1512 of the lattice unit cell 15 disposed at the outermost side of the three-dimensional base structure 10 and having no connection with the adjacent lattice unit cells 15 are closed. That is, the flat circular walls 1512 at the outermost side of the three-dimensional base structure 10 have no through holes 153. Therefore, when the second material is filled into the lattice unit cells 15 to form the filled structure 20, the second material will not escape out of the three-dimensional base structure 10. A filling hole is formed on one of the flat circular walls 1512 for filling the second material into the three-dimensional base structure 10. The second material flows into the lattice unit cell 15 having the filling hole and further flows into other lattice unit cells 15 through the through holes 153. Finally, the cavity 12 is fully filled by the second material, and the solid composite additive structure is thus obtained.

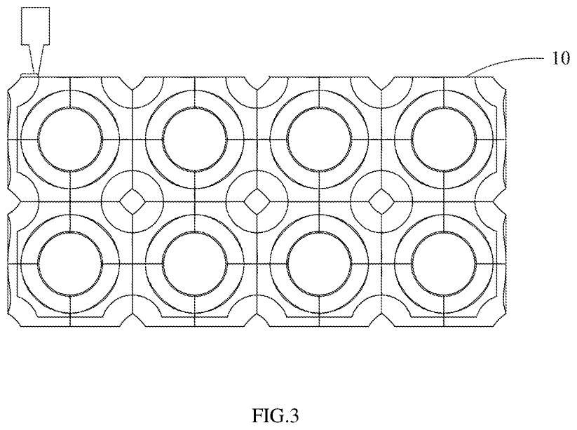

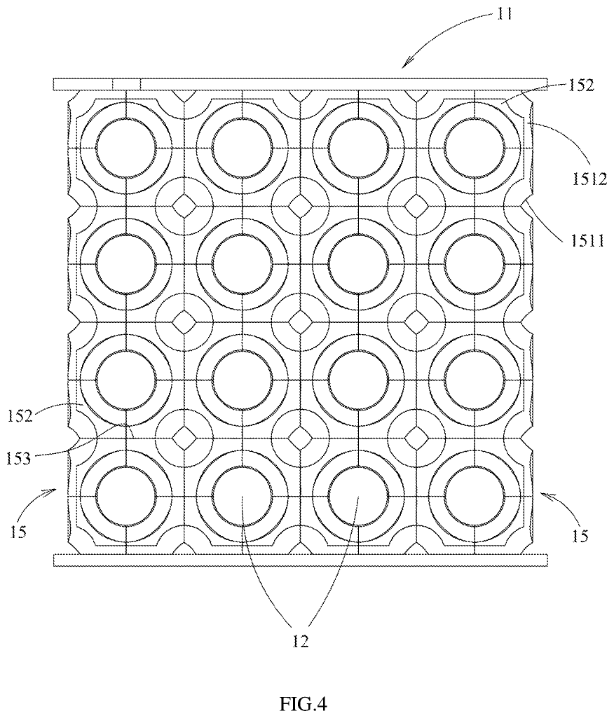

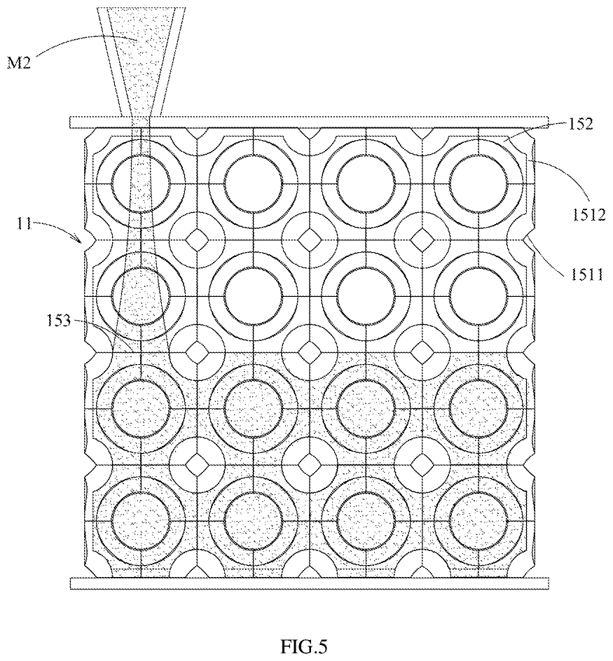

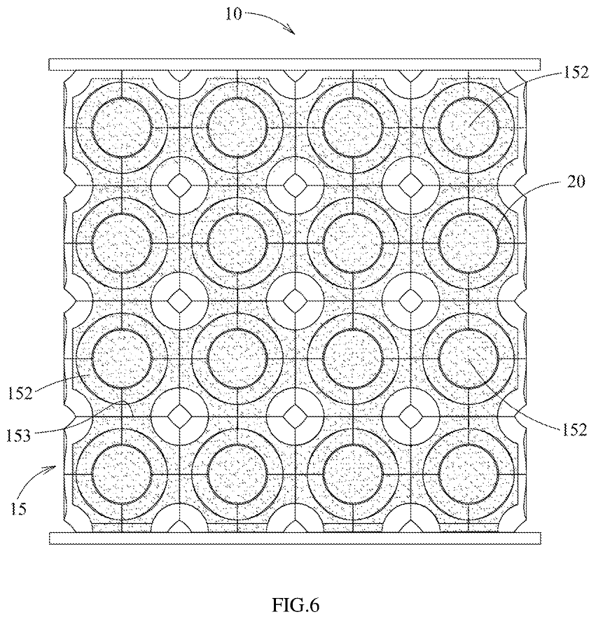

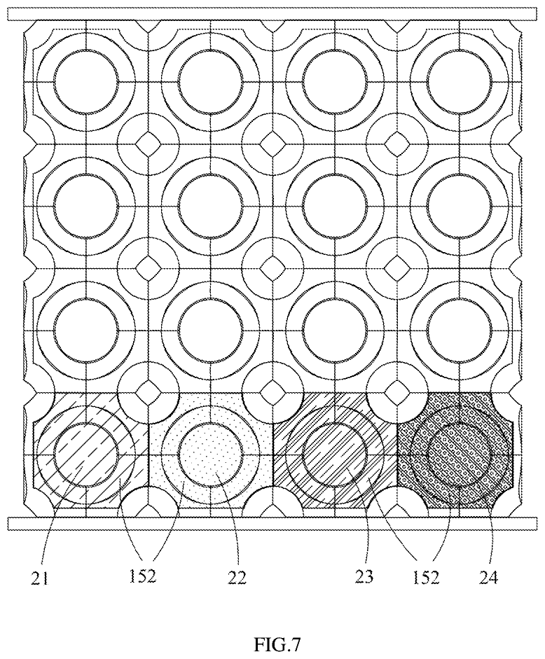

Referring to FIGS. 3, 4, 5, and 6, the process of manufacturing the composite additive structure is shown. The three-dimensional base structure 10 is manufactured by the additive manufacturing technology with the first material, and the second material is filled into the cavity 12 of the three-dimensional base structure 10. As shown in FIG. 3, the first material is melted and squeezed onto a forming member, and solidified thereon. The solidified first material is stacked on the forming member layer by layer to form the three-dimensional base structure 10. As shown in FIG. 4, finally, the three-dimensional base structure 10 having a plurality of lattice unit cells 15 is obtained. Afterward, as shown in FIG. 5, the second material M2 is filled into the lattice unit 15 of the three-dimensional base structure 10 through the filling hole. The second material M2 flows to other lattice units 15 through the through holes 153. As shown in FIG. 6, finally, the second material M2, fully fills all unit cavities 152 of the three-dimensional base structure 10, the cavity 12 of the three-dimensional base structure 10, whereby the solid composite additive structure is obtained. As shown in FIG. 7, the second material M2 can also be filled in limited quantity to obtain a partially filled three-dimensional base structure 10 (include FIG. 7 of partially filled three-dimensional base structure). The first material is used for additive manufacturing process, and the second material is used for the filling process.

Referring to FIG. 7, a plurality of second materials 21, 22, 23 and 24, which have different physical or/and chemical properties, are filled in the unit cavities 152 of different lattice units 15 of the three-dimensional base structure 10. The different second materials 21, 22, 23 and 24 can be filled one-by-one in adjacent lattice units 15.

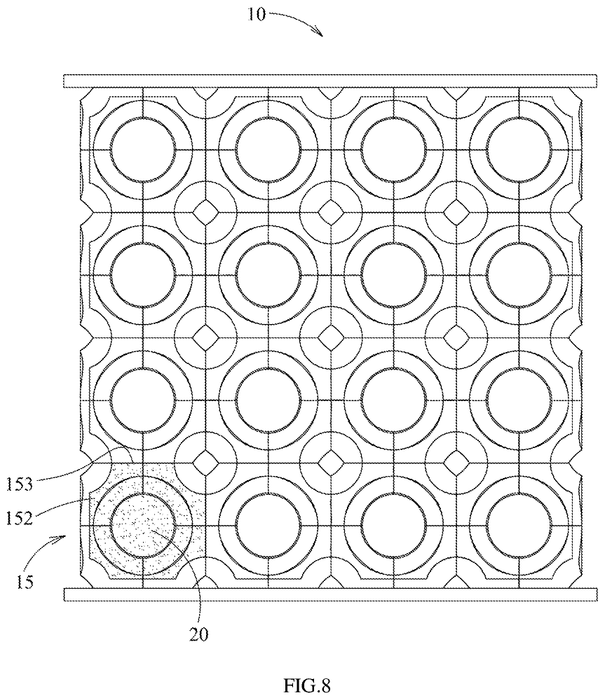

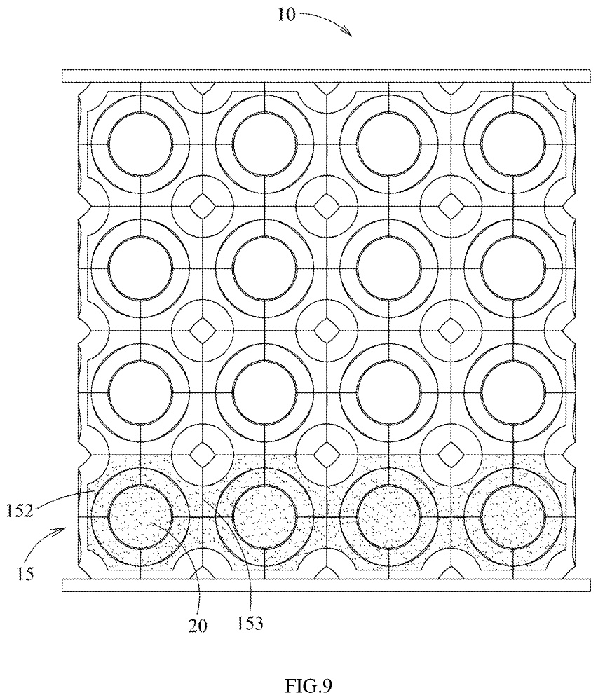

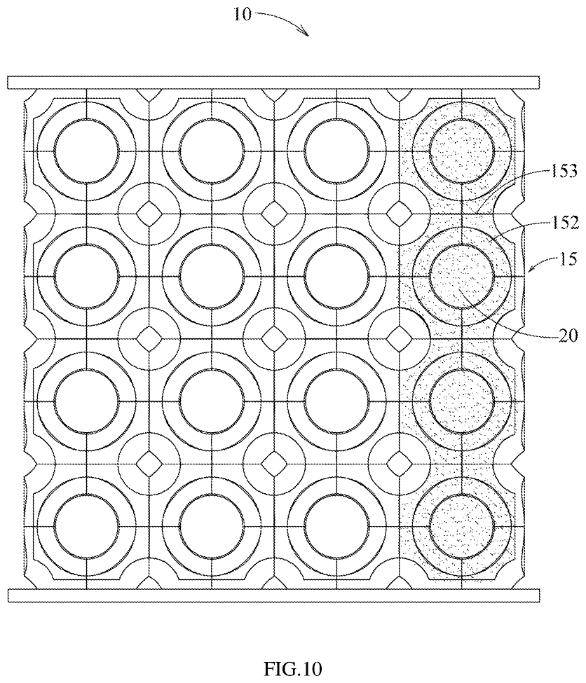

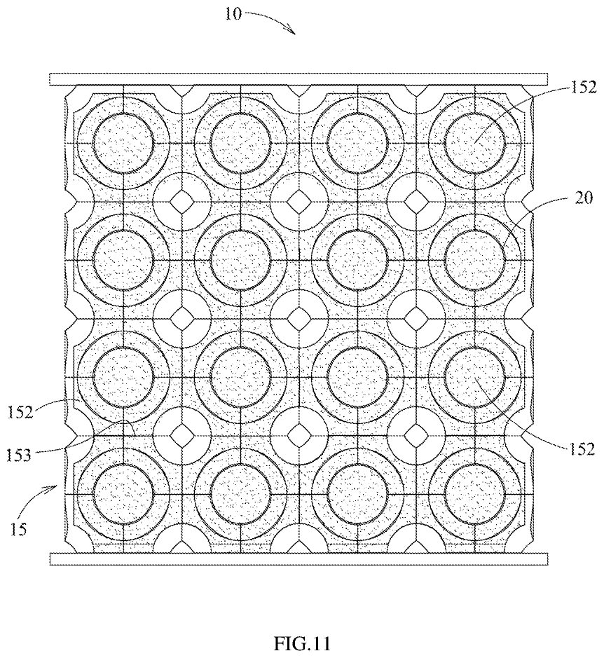

Referring to FIGS. 8, 9, 10 and 11, three types of filling strategies can be followed. As shown in FIG. 8, in the first strategy, the second material M2 is filled in individual unit lattice cell 15, in which the unit lattice cell 15 is individually closed by flat circular wall 1512, also called as local filling. As shown in FIGS. 9 and 10, in the second strategy, the second material M2 is filled in horizontal and/or vertical array of lattice unit cells 15, also called as layer filling. As shown in FIG. 11, in the third strategy, the second material M2 is filled in a complete three-dimensional additive structure 10, in which unit lattice cell 15 has no circular flat walls 1512 and is propagated in the first direction, second direction and third direction through an opening, also called as global filling.

The first material is a linear or non-linear material conventionally used in the fused filament fabrication (FFF) technology such as polymer material. The second material can be liquid material, gel material, foam material, or powder material.

When the second material is liquid material such as water, oil, shear thickening fluids, electro-, and magneto-rheological fluids or gel material such as hydrogels or aerogels, the second material fully/partially fills the cavity 12 of the three-dimensional base structure 10 without generation of porosity. As the liquid material is incompressible, the second material is able to provide support for the hollow three-dimensional base structure 10 formed by soft polymer material and enhances the overall structural strength of the composite additive structure.

When the second material is foam material, including polymer and metallic foams such as polyurethane foam, silicone foams, aluminum foams, etc., the second material has a porous structure as it is filled into the cavity 12 of the three-dimensional base structure 10. In addition to the enhancement of the overall structural strength, the second material also provides more elasticity for the composite additive structure.

When the second material is powder material such as polymer powder, metal powder, and ceramic powder, the second material is able to provide support for the three-dimensional base structure 10 and enhance the overall structural strength.

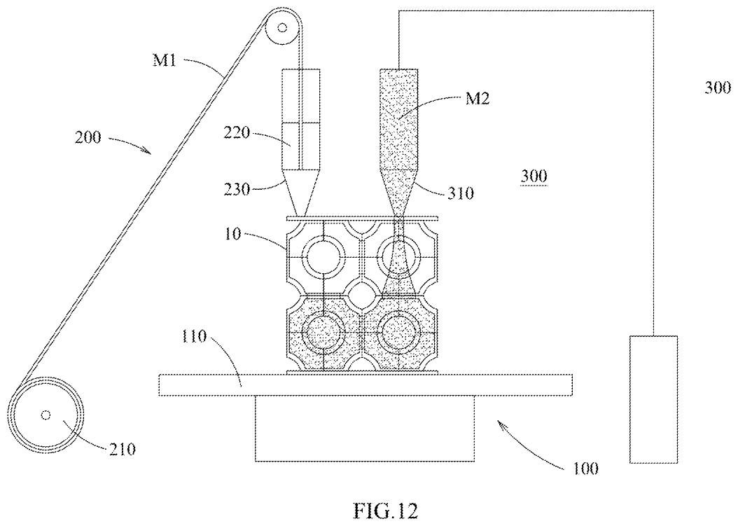

Referring to FIG. 12, an embodiment of a composite additive manufacturing equipment is shown. The composite additive manufacturing equipment includes a forming stage 100, a first material supply module 200, and a second material supply module 300. The forming stage 100 includes a forming member 110 for the additive product formed thereon.

The first material supply module 200 includes a material supply member 210, a heater 220, and a first nozzle 230. The first material M1 is linear and wound on the material supply member 210. One end of the linear/non-linear first material M1 is pulled into the heater 220 and melted therein. The molten first material M1 is squeezed out from the first nozzle 230. The squeezed first material M1 is coated on the forming member 110 layer by layer. The first material M1 is cooled and solidified on the forming member 110 to form the structure of each two-dimensional layer. The stacked two-dimensional layers form the three-dimensional base structure 10, including the structures of the shell 11 and the cavity 12.

The second material supply module 300 includes a second nozzle 310. The second material is discharged from the second nozzle 310 and filled into the cavity 12 of the three-dimensional base structure 10.

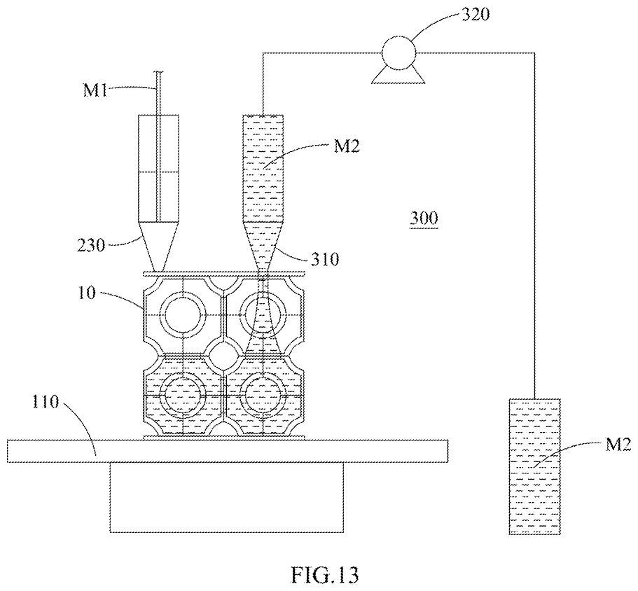

Referring to FIG. 13, a first embodiment of the second material supply module 300 is shown. The first embodiment of the second material supply module 300 is adapted to the case that the second material M2 is liquid material or gel material. In the present embodiment, the second material supply module 300 further includes a pressurizing member 320. The pressurizing member 320 is a liquid pump in the present embodiment. The pressurizing member 320 pressurizes the second material M2 to convey the second material M2 to the second nozzle 310. The pressurized second material M2 is squeezed from the second nozzle 310 and filled into the cavity 12 of the three-dimensional base structure 10.

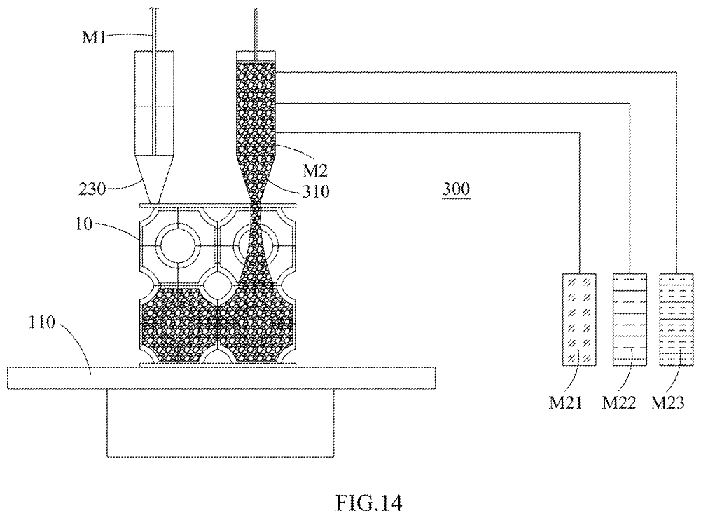

Referring to FIG. 14, a second embodiment of the second material supply module 300 is shown. The second embodiment of the second material supply module 300 is adapted to the case that the second material M2 is foam material. The present embodiment uses polyurethane foam as an example. The second material M2 includes a first composition material M21, a second composition material M22 and a third composition material M23. The first composition material M21 is, for example, a polyol material with additives, including blowing agents. The second composition material M22 is, for example, isocyanate. The third composition material M23 is for cleaning the residual uncured foam from the nozzle, which is acetone in this case. The first composition material M21, the second composition material M22 are squeezed by plungers driven by stepping motors, and the squeezed first composition material M21, the squeezed second composition material M22 are conveyed to the second nozzle 310. The second nozzle 310 is a dynamic or a static mixing unit. The first composition material M21, the second composition material M22 are mixed in the second nozzle 310 and react therein to generate foam material. The foam material is squeezed from the second nozzle 310 and filled into the cavity 12 of the three-dimensional base structure 10. The uncured foam residual in the nozzle is cleaned using the third composition material M23 which is squeezed by a plunger driven by stepper motors into the second nozzle 310.

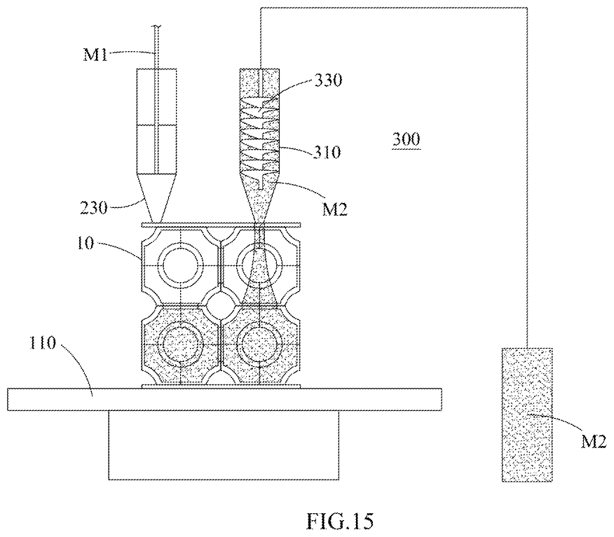

Referring to FIG. 15, a third embodiment of the second material supply module 300 is shown. The third embodiment of the second material supply module 300 is adapted to the case that the second material M2 is powder material. The second material supply module 300 further includes a screw 330 disposed in the second nozzle 310. The second material M2 is conveyed from a tank to the second nozzle 310 and pushed by the screw 330 to discharge from second nozzle 310. The discharged second material M2 is filled into the cavity 12 of the three-dimensional base structure 10.

The second material is filled into the three-dimensional base structure manufactured by the additive manufacturing technology with the first material and forms the filled structure therein, whereby the composite additive structure of the present invention having filled structure of the second material enclosed by the shell made of the first material enclosing is obtained. The three-dimensional base structure can be any shape. The volume proportion of the cavity to the entire three-dimensional base structure can be adjusted to obtain different combinations of the filled structure and the three-dimensional base structure, whereby the composite additive structures having different mechanical properties are thus obtained. In addition, the composite additive manufacturing equipment of the present invention includes the first material supply module and the second material supply module. The first material supply module provides the first material to form the three-dimensional base structure on the forming member, and the second material supply module provides the second material filled in the chamber. The second material supply module have different structures according to the second material for the discharge of the second material.

The composite additive manufacturing equipment of the present invention can accomplish the additive manufacturing for the three-dimensional base structure and the filling of the second material for the filled structure in a single process.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

The composite additive structure thus obtained can be used in applications such as space equipment, sporting and protection goods, defense and automobile components, and so forth.

What is claimed is:

1. A composite additive structure, comprising:
a three-dimensional base structure formed by additive manufacturing process with a supportless structure, wherein the three-dimensional base structure comprises a shell and a cavity enclosed by the shell; and
a filled structure filled in the cavity and connected to the shell to form a solid composite structure.

2. The composite additive structure as claimed in claim 1, wherein the three-dimensional base structure comprises a plurality of lattice unit cells which are hollow, the lattice units are stacked in a first direction, a second direction and a third direction, each of the lattice units comprises a unit shell and a unit cavity enclosed by the unit shell, the unit shell of each of the lattice unit cell is connected to the unit shell of the adjacent lattice units in the first direction, the second direction and the third direction, and the filled structure is formed in the unit cavities.

3. The composite additive structure as claimed in claim 2, wherein each of the lattice unit cell has through holes on the unit shell in the first direction, the second direction or the third direction, the unit cavity of each of the lattice unit cells communicates with the unit cavities of the adjacent lattice unit cells through the through holes, and the filled structure filled in each of the unit cavity is connected to the filled structure filled in the adjacent unit cavity.

4. The composite additive structure as claimed in claim 3, wherein the unit shell of each of the lattice unit cell comprises a spherical shell and a plurality of flat circular walls, the flat circular walls are disposed on the spherical shell in the first direction, the second direction and the third direction, and the through holes are formed on the flat circular walls in at least one of the first direction, the second direction and the third direction.

5. The composite additive structure as claimed in claim 4, wherein the flat circular wall has a thickness less than, equal to or greater than that of the spherical shell.

6. The composite additive structure as claimed in claim 4, wherein the flat circular walls of the lattice unit disposed at the outermost side of the three-dimensional base structure and having no connection with the adjacent lattice unit are closed.

7. The composite additive structure as claimed in claim 2, wherein a ratio of a thickness of the unit shell over the length of each of the lattice units ranges from 0.05 to 0.3, and a ratio of the volume of the unit cavity over the total volume of the lattice unit ranges from 0.1 to 0.7.

8. The composite additive structure as claimed in claim 1, wherein the filled structure is formed by liquid material, gel material, foam material or powder material.

9. The composite additive structure as claimed in claim 1, wherein the filled structure could be fully filled or partially filled with second material.

10. A composite additive manufacturing equipment, comprising:
a forming stage comprising a forming member;
a first material supply module providing a first material stacked on the forming member layer by layer to form the three-dimensional base structure of the composite additive structure as claimed in claim 1; and
a second material supply module providing a second material filled in the cavity of the three-dimensional base structure to form the composite additive structure as claimed in claim 1.

11. The composite additive manufacturing equipment, as claimed in claim 10, wherein the second material supply module provides a plurality of second materials, which have different physical or/and chemical properties, filled in different lattice unit cells of the three-dimensional base structure.

12. The composite additive manufacturing equipment as claimed in claim 10, wherein the second material can be filled using local filling, layer filling and/or global filling strategy.

13. The composite additive manufacturing equipment as claimed in claim 10, wherein the first material supply module comprises a heater and a first nozzle, the first material is molten by the heater and squeezed from the first nozzle to be stacked on the forming member to form the three-dimensional base structure, the second material supply module comprises a second nozzle, and the second material is squeezed from the second nozzle.

14. The composite additive manufacturing equipment as claimed in claim 13, wherein the second material is a liquid material; the second material supply module further comprises a pressurizing member pressurizing the second material to be squeezed from the second nozzle.

15. The composite additive manufacturing equipment as claimed in claim 13, wherein the second material comprises a first composite material and a second composite material, the first composite material and the second composite material are mixed the second nozzle to generate a foam material which is squeezed from the second nozzle.

16. The composite additive manufacturing equipment as claimed in claim 13, wherein the second material is powder material, the second nozzle comprises a main body and a screw disposed in the main body, the second material is transmitted to the main body and pushed by the screw, whereby the second material is squeezed from the second nozzle.
